(19) United States
(12) Patent Application Publication
(10) Pub. No.: US 2025/0105748 A1
(43) Pub. Date: Mar. 27, 2025

(54) INPUT-PARALLEL MULTI-CONVERTER SWITCHING POWER SUPPLY

(71) Applicant: Chengdu Monolithic Power Systems Co., Ltd., Chengdu (CN)

(72) Inventor: Hui Li, Hangzhou (CN)

(21) Appl. No.: 18/898,435

(22) Filed: Sep. 26, 2024

(30) Foreign Application Priority Data
Sep. 27, 2023 (CN) 202311266363.5

(51) Int. Cl. H02M 3/335; H02M 1/00

(52) U.S. Cl. CPC H02M 3/33507; H02M 1/0043

(57) ABSTRACT

A multi-converter switching power supply has a first switching converter, a second switching converter, a first port, a second port, and an integrated control circuit. The first switching converter receives an input voltage, converts the input voltage to a first output voltage, provides the first output voltage to a first output terminal and a second output terminal. The second switching converter receives the input voltage, converts the input voltage to a second output voltage, and provides the second output voltage to a third output terminal and a fourth output terminal. The second output terminal is coupled to the fourth output terminal. The first port has a first bus terminal for receiving a first voltage and a first ground terminal coupled to the second output terminal. The second port has a second bus terminal for receiving a second voltage and a second ground terminal coupled to the fourth output terminal.

### CROSS-REFERENCE TO RELATED APPLICATIONS

This application claims the benefit of CN application No. 202311266363.5, filed on Sep. 27, 2023, and incorporated herein by reference.

### BACKGROUND OF THE INVENTION

### 1. Field of the Invention

The present invention relates to electronic circuits, and more particularly to multi-converter switching power supplies.

### 2. Description of Related Art

Conventional solutions for multiple output power delivery (PD) adapters typically employ a two-stage design to convert an input power to an expected output power. A first stage power converter (e.g., a flyback converter or an LLC resonant converter) can convert high voltage alternating current (AC) power to lower voltage direct current (DC) power. A second stage power converter (e.g., a buck converter) can convert power output from the first stage to different DC power to meet different requirements.

However, not all outputs need to be loaded at the same time. As the number or characteristics of a load changes, power requirements also change. Multi-stage power converters capable of meeting various power requirements may be difficult to design, expensive, and/or inefficient to implement, particularly when multi-stage converters have to meet different requirements in order to be compatible with each other.

### SUMMARY OF THE INVENTION

It is one of the objects of the present invention to provide an input-parallel multi-converter switching power supply.

One embodiment of the present invention discloses a multi-converter switching power supply. The multi-converter switching power supply has a first switching converter, a second switching converter, a first port, a second port, and an integrated control circuit. The first switching converter receives an input voltage, converts the input voltage to a first output voltage, and provides the first output voltage to a first output terminal and a second output terminal. The second switching converter receives the input voltage, converts the input voltage to a second output voltage, and provides the second output voltage to a third output terminal and a fourth output terminal. The second output terminal is coupled to the fourth output terminal. The first port has a first bus terminal for receiving a first voltage and a first ground terminal coupled to the second output terminal. The second port has a second bus terminal for receiving a second voltage and a second ground terminal coupled to the fourth output terminal. The integrated control circuit has a first pin, a second pin, a third pin and a switching control circuit. The first pin receives a first feedback signal representing the first output voltage. The second pin receives a second feedback signal representing the second output voltage. The third pin receives a mode signal, the mode signal controls the multi-converter switching power supply to operate in a first power supply mode or a second power supply mode. The switching control circuit controls the first switching converter and the second switching converter. When the multi-converter switching power supply operates in the first power supply mode, the first output terminal and the third output terminal are both coupled to the first bus terminal, the switching control circuit controls the first switching converter and the second switching converter to operate interleaved with each other based on the first feedback signal. When the multi-converter switching power supply operates in the second power supply mode, the first output terminal is coupled to the first bus terminal, the third output terminal is coupled to the second bus terminal, the switching control circuit is configured to control the first switching converter to provide the first voltage based on the first feedback signal, and the switching control circuit controls the second switching converter to provide the second voltage based on the second feedback signal.

Another embodiment of the present invention discloses an integrated control circuit for a multi-converter switching power supply. The integrated control circuit has a first pin, a second pin, a third pin, and a switching control circuit. The first pin receives a first feedback signal representing a first output voltage of the multi-converter switching power supply. The second pin receives a second feedback signal representing a second output voltage of the multi-converter switching power supply. The third pin receives a mode signal controlling the multi-converter switching power supply to operate in a first power supply mode or a second power supply mode. The switching control circuit controls a first switching converter and a second switching converter of the multi-converter switching power supply. When the multi-converter switching power supply operates in the first power supply mode, inputs of a first switching converter of the multi-converter switching power supply and inputs of a second switching converter of the multi-converter switching power supply are connected in parallel, and outputs of the first switching converter and outputs of the second switching converter are connected in parallel, the switching control circuit controls the first switching converter and the second switching converter to operate interleaved with each other based on the first feedback signal to provide a first voltage to a first bus terminal of a first port. When the multi-converter switching power supply operates in a second power supply mode, the inputs of the first switching converter and the inputs of the second switching converter are connected in parallel, the switching control circuit controls the first switching converter to provide the first output voltage to the first bus terminal of the first port based on the first feedback signal, the switching control circuit controls the second switching converter to provide the second output voltage to a second bus terminal of a second port based on the second feedback signal.

Yet another embodiment of the present invention discloses a control method for a multi-converter switching power supply. The control method for a multi-converter switching power supply comprises the following steps. Converting an input voltage to a first output voltage and providing the first output voltage to a first output terminal and a second output terminal. Converting the input voltage to a second output voltage and providing the second output voltage to a third output terminal and a fourth output terminal, wherein the second output terminal is coupled to the fourth output terminal. Receiving a mode signal controlling the multi-converter switching power supply to operate in a first power supply mode or a second power supply mode. In response to the multi-converter switching power supply operating in the first power supply mode, coupling both the first output terminal and the third output terminal to a first bus terminal of a first port, receiving a first feedback signal representing the first output voltage, and controlling a first switching converter of the multi-converter switching power supply and a second switching converter of the multi-converter switching power supply to operate interleaved with each other based on the first feedback signal to provide a first voltage for the first bus terminal. In response to the multi-converter switching power supply operating in the second power supply mode, coupling the first output terminal to the first bus terminal, coupling the third output terminal to a second bus terminal of a second port, receiving the first feedback signal, and receiving a second feedback signal representing the second output voltage at the same time, controlling the first switching converter to convert the input voltage to the first output voltage based on the first feedback signal, and to provide the first output voltage to the first bus terminal, and controlling the second switching converter to convert the input voltage to the second output voltage based on the second feedback signal, and to provide the second output voltage to the second bus terminal.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically illustrates a circuit diagram of a multi-converter switching power supply 100 in accordance with an embodiment of the present invention.

FIG. 2 schematically illustrates a circuit diagram of a multi-converter switching power supply 100A in accordance with an embodiment of the present invention.

FIG. 3 schematically illustrates a circuit diagram of a multi-converter switching power supply 100B in accordance with an embodiment of the present invention.

FIG. 4 schematically illustrates a circuit diagram of an integrated control circuit 103B in accordance with an embodiment of the present invention.

FIG. 5 schematically illustrates a flowchart of a control method for a multi-converter switching power supply in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

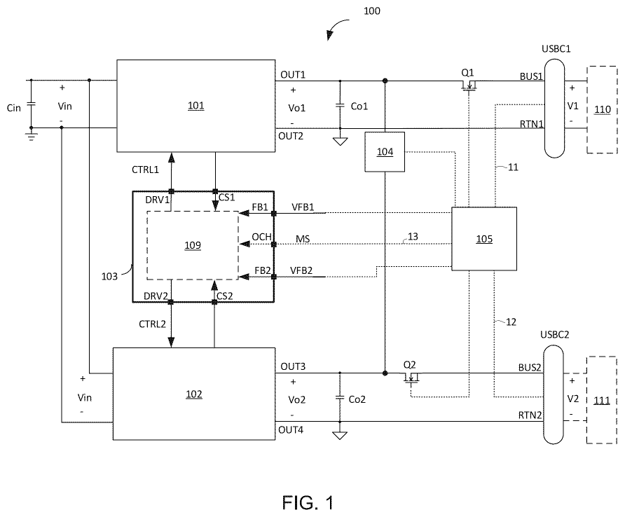

FIG. 1 schematically illustrates a circuit diagram of a multi-converter switching power supply 100 in accordance with an embodiment of the present invention. For convenience, the multi-converter switching power supply 100 is illustrated as merely having two USB port outputs (USBC1 and USBC2). In other embodiments, the multi-converter switching power supply 100 includes additional output(s) and/or output(s) other than USB ports.

In the embodiment shown in FIG. 1, the multi-converter switching power supply 100 includes a first switching converter 101, a second switching converter 102, a first port USBC1, a second port USBC2, an integrated control circuit 103, a load switch 104, and a power delivery (PD) controller 105.

As shown in FIG. 1, the first switching converter 101 has a first input terminal, a second input terminal, a first output terminal OUT1, and a second output terminal OUT2. The first input terminal and the second input terminal are coupled across the input capacitor Cin respectively to receive an input voltage Vin. The first switching converter 101 converts the input voltage Vin to a first output voltage Vo1 and provides the first output voltage Vo1 to the first output terminal OUT1 and the second output terminal OUT2. The second switching converter 102 has a third input terminal and a fourth input terminal, a third output terminal OUT3 and a fourth output terminal OUT4. The third input terminal and the fourth input terminal are coupled across the input capacitor Cin respectively to receive the input voltage Vin. The second switching converter 102 converts the input voltage Vin to a second output voltage Vo2 and provides the second output voltage Vo2 to the third output terminal OUT3 and the fourth output terminal OUT4. The second output terminal OUT2 is coupled to the fourth output terminal OUT4 and grounded together.

In one embodiment, the input capacitor Cin is configured to receive a high voltage input. In some embodiments, the high voltage input is an alternating current (AC) input, such as a line voltage. In other embodiments, the high voltage input is a high voltage direct current (DC) input, such as an EMI filtered and rectified line voltage.

In order to filter ripple and stabilize the output voltage, both output terminals of the first switching converter 101 and the second switching converter 102 are coupled to an output capacitor. As shown in FIG. 1, an output capacitor Co1 is coupled between the first output terminal OUT1 and the second output terminal OUT2 of the first switching converter 101 to receive the first output voltage Vo1. An output capacitor Co2 is coupled between the third output terminal OUT3 and the fourth output terminal OUT4 of the second switching converter 102 to receive the second output voltage Vo2. Considering capacity, price and volume, the output capacitors Co1 and Co2 are generally made of electrolytic capacitors, such as aluminum electrolytic capacitors.

The first port USBC1 has a bus terminal BUS1 and a ground terminal RTN1, and the bus terminal BUS1 receives a first voltage V1 and the ground terminal RTN1 is coupled to ground. The second port USBC2 has a bus terminal BUS2 and a ground terminal RTN2, and the bus terminal BUS2 receives the second voltage V2 and the ground terminal RTN2 is coupled to ground. In some cases, at least one port is not connected to an external electronic device. For example, only the first port USBC1 is coupled to a first electronic device 110 and the second port USBC2 is disconnected from a second electronic device 111 (i.e., the second port USBC2 is floating). Thus, as shown in FIG. 1, a connection of the second port USBC2 to the second electronic device 111 is illustrated with a dashed line. In one embodiment, the first port USBC1 and the second port USBC2 are both Type-C ports.

The power delivery controller 105 is configured to control selection switches Q1 and Q2 and the load switch 104 to detect power requirements of respective ports USBC1 and USBC2 and thereby customize power outputs of the respective ports USBC1 and USBC2. In this manner, various power requirements for different numbers of loads are met. The selection switch Q1 is coupled between the first output terminal OUT1 and the bus terminal BUS1, and the selection switch Q2 is coupled between the third output terminal OUT3 and the bus terminal BUS2.

The power delivery controller 105 is coupled to the first port USBC1 and the second port USBC2 via wires 11 and 12 respectively to determine that the multi-converter switching power supply operates in a first power supply mode or a second power supply mode, and provide a mode signal MS. The first power supply mode indicates that only the first port USBC1 is coupled to the first electronic device 110 and the second port USBC2 is not coupled to the second electronic device 111. The second power supply mode indicates that the first port USBC1 is coupled to the first electronic device 110 and the second port USBC2 is coupled to the second electronic device 111. In addition, the power delivery controller 105 is coupled to the integrated control circuit 103 as well, and provides a first feedback signal VFB1 representing the first output voltage Vo1 and a second feedback signal VFB2 representing the second output voltage to the integrated control circuit 103 respectively.

The first switching converter 101 and the second switching converter 102 could have the same topology. In one embodiment, both the first switching converter 101 and the second switching converter 102 are flyback converters. Both the first switching converter 101 and the second switching converter 102 are controlled by the integrated control circuit 103. In one embodiment, the integrated control circuit 103 provides a first control signal CTRL1 and a second control signal CTRL2 to control a first switch of the first switching converter 101 and a second switch of the second switching converter 102 respectively. In another embodiment, the integrated control circuit 103 is integrated on the same chip with the first switch and the second switch.

In the embodiment shown in FIG. 1, the integrated control circuit 103 includes a switching control circuit 109 and a plurality of pins including a first feedback pin FB1, a second feedback pin FB2, a mode indicating pin OCH, a first drive pin DRV1, a first current sense pin CS1, a second drive pin DRV2, and a second current sense pin CS2. The first feedback pin FB1 is coupled to an output of the first switching converter 101 and receives the first feedback signal VFB1 representing the first output voltage Vo1. The second feedback pin FB2 is coupled to an output of the second switching converter 102 and receives the second feedback signal VFB2 representing the second output voltage Vo2. The mode indicating pin OCH is coupled to the power delivery controller 105 via a wire 13 and receives the mode signal MS controlling the multi-converter switching power supply to operate in the first power supply mode or second power supply mode.

When the multi-converter switching power supply 100 operates in the first power supply mode, the load switch 104 coupled between the first output terminal OUT1 and the third output terminal OUT3 is turned on, and the selection switch Q1 coupled between the first output terminal OUT1 and the bus terminal BUS1 is turned on. In this case, the first output terminal OUT1 and the third output terminal OUT3 are both coupled to the bus terminal BUS1 of the first port USBC1, and the switching control circuit 109 controls the first switching converter 101 and the second switching converter 102 to operate interleaved with each other based on the first feedback signal VFB1. So that the first switching converter 101 and the second switching converter 102 provide the first voltage V1 to the bus terminal BUS1 together. Thereby providing double current load capability to the first electronic device 110.

When the multi-converter switching power supply operates in the second power supply mode, the load switch 104 coupled between the first output terminal OUT1 and the third output terminal OUT3 is turned off, the switch Q1 coupled between the first output terminal OUT1 and the bus terminal BUS1 remains on, and the selection switch Q2 coupled between the third output terminal OUT3 and the bus terminal BUS2 is turned on. In such an embodiment, the third output terminal OUT3 is decoupled from the bus terminal BUS1 and the first output terminal OUT1. And then the third output terminal OUT3 is coupled to the bus terminal BUS2 of the second port USBC2. The switching control circuit 109 controls the first switching converter 101 to provide the first output voltage Vo1 based on the first feedback signal VFB1, in order to power the first electronic device 110. The first output voltage Vo1 is provided as the first voltage V1 supplied to the first port USBC1. At the same time, the switching control circuit 109 controls the second switching converter 102 to provide the second output voltage Vo2 based on the second feedback signal VFB2, in order to power the second electronic device 111. The second output voltage Vo2 is provided as the second voltage V2 supplied to the second port USBC2.

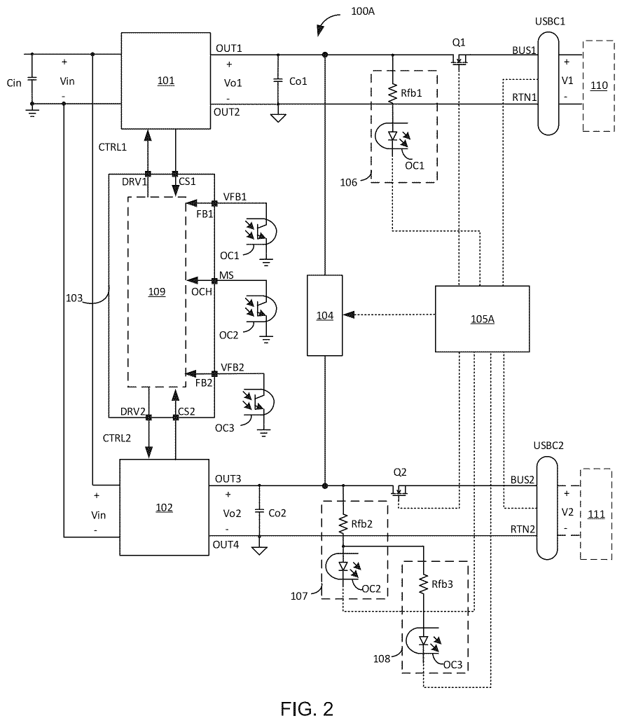

FIG. 2 schematically illustrates a circuit diagram of a multi-converter switching power supply 100A in accordance with an embodiment of the present invention. As shown in FIG. 2, comparing with the multi-converter switching power supply 100 shown in FIG. 1, the multi-converter switching power supply 100A further includes a first isolated delivery path 106, a second isolated delivery path 107, and a third isolated delivery path 108.

When detection of the first power supply mode and the second power supply mode and sensing of the first output voltage Vo1 and the second output voltage Vo2 are conducted at a secondary side of the switching converter, the isolated delivery paths are required. In some embodiments, the isolated delivery path may include an optocoupler, a transformer, a capacitive isolation device, or any other suitable electrical isolation device.

In the embodiment shown in FIG. 2, the first feedback pin FB1 of the integrated control circuit 103 receives the first feedback signal VFB1 via the first isolated delivery path 106. The first feedback signal VFB1 is an error amplifying signal of the first output voltage Vo1. Specifically, the first isolated delivery path 106 includes a feedback resistor Rfb1, a photocoupler OC1, and a three-terminal adjustable voltage regulator device (not shown). In one embodiment, the three-terminal adjustable voltage regulator device comprises a semiconductor device (e.g., model TL431) integrated within a power delivery controller 105A. The photocoupler OC1 comprises a photosensitive diode and a photosensitive transistor. The photosensitive diode has an anode and a cathode, the anode is coupled to the first output terminal OUT1 via the feedback resistor Rfb1, and the cathode is coupled to one terminal of the power delivery controller 105A. When the multi-converter switching power supply 100A operates in the first power supply mode or the second power supply mode, the power delivery controller 105A converts the error amplifying signal of the first output voltage Vo1 to a current flowing through the photosensitive diode. The photosensitive transistor is coupled between the first feedback pin FB1 of the integrated control circuit 103 and the second input terminal of the first switching converter 101. The photosensitive transistor provides the first feedback signal VFB1 in response to the current flowing through the photosensitive diode, the first feedback signal VFB1 is input to the switching control circuit 109 to control the operation thereof.

Similarly, when the multi-converter switching power supply 100A operates in the second power supply mode, the second feedback pin FB2 of the integrated control circuit 103 receives the second feedback signal VFB2 via the second isolated delivery path 107. The second feedback signal VFB2 is an error amplifying signal of the second output voltage Vo2. Specifically, the second isolated delivery path 107 includes a feedback resistor Rfb2, a photocoupler OC2, and a three-terminal adjustable voltage regulator device (integrated within the power delivery controller 105A as well). The photocoupler OC2 also comprises a photosensitive diode and a photosensitive transistor. When the multi-converter switching power supply 100A operates in the second power supply mode, the power delivery controller 105A provides the error amplifying signal of the second output voltage Vo2 to the second feedback pin FB2 of the integrated control circuit 103, the second feedback signal VFB2 is input to the switching control circuit 109 to control the operation of the switching control circuit.

The mode indicating pin OCH of the integrated control circuit 103 receives the mode signal MS via the third isolated delivery path 108. In the embodiment shown in FIG. 2, the mode signal MS is related to the second output voltage Vo2. In another embodiment, the mode signal MS may be related to the first output voltage Vo1. In other embodiments, the mode signal MS may be provided to the integrated control circuit 103 by other ways. Specifically, the third isolated delivery path 108 includes a feedback resistor Rfb3, a photocoupler OC3, and the three-terminal adjustable voltage regulator device (also integrated within the power delivery controller 105A). When the multi-converter switching power supply 100A operates in the first power supply mode or the second power supply mode, the power delivery controller 105A provides a signal related to the second output voltage Vo2 to the mode indicating pin OCH of the integrated control circuit 103, and the signal is input to the switching control circuit 109 to control the operation thereof.

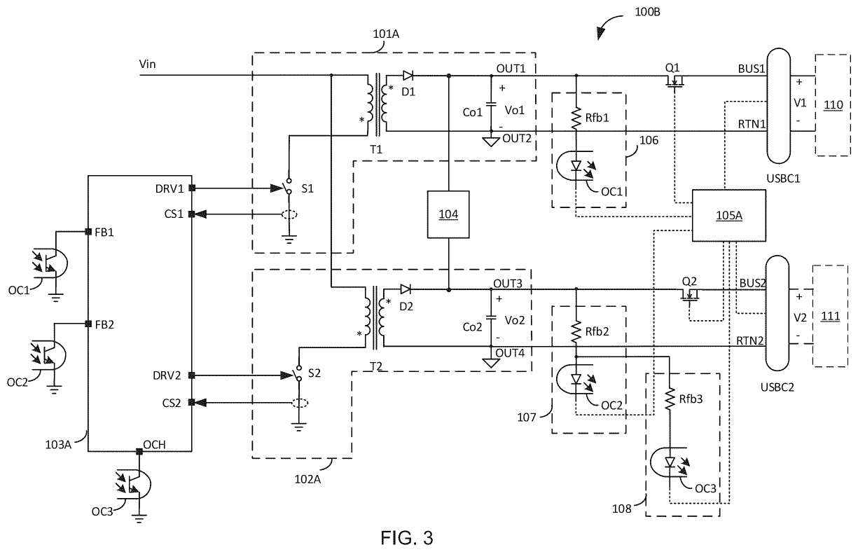

FIG. 3 schematically illustrates a circuit diagram of a multi-converter switching power supply 100B in accordance with an embodiment of the present invention. In the embodiment shown in FIG. 3, a first switching converter 101A and a second switching converter 102A are both flyback circuits. The first switching converter 101A comprises a switch S1, a transformer T1 and a diode D1, and the second switching converter 102A comprises a switch S2, a transformer T2 and a diode D2.

As shown in FIG. 3, the first switching converter 101A has a first output capacitor Co1, and the first switching converter 101A converts the input voltage Vin to the first output voltage Vo1. As shown in FIG. 3, the second switching converter 102A has a second output capacitor Co2, the second switching converter 102A converts the input voltage Vin to the second output voltage Vo2. An integrated control circuit 103A comprises the first feedback pin FB1, the second feedback pin FB2, the mode indicating pin OCH, the first drive pin DRV1, the first current sense pin CS1, the second drive pin DRV2 and the second current sense pin CS2. The first feedback pin FB1 receives a first feedback signal VFB1 representing the first output voltage Vo1 via the first isolated delivery path 106. The second feedback pin FB2 receives the second feedback signal VFB2 representing the second output voltage Vo2 via the second isolated delivery path 107. The mode indicating pin OCH receives the mode signal MS via the third isolated delivery path 108. Based on the mode signal MS, the switching control circuit 109 determines the control mode of its internal circuit.

In response to the multi-converter switching power supply 100B operating in the first power supply mode, inputs of the first switching converter 101A and inputs of the second switching converter 102A are connected in parallel, and an output of first switching converter 101A and an output of the second switching converter 102A are connected in parallel. The switching control circuit 109 is coupled to the first feedback pin FB1 and the first current sense pin CS1. The switching control circuit 109 controls the first switching converter 101A and the second switching converter 102A to operate interleaved with each other based on the first feedback signal VFB1 and a first current sense signal characterizing a current flowing through the switch S1. The first switching converter 101A and the second switching converter 102A provide the first voltage V1 to the bus terminal BUS1 of the first port USBC1. In response to the multi-converter switching power supply 100B operating in the second power supply mode, the inputs of the first switching converter 101A and the inputs of the second switching converter 102A are connected in parallel, and the output of the first switching converter 101A and the output of the second switching converter 102A are independent from each other. The switching control circuit 109 is coupled to the first feedback pin FB1 and the first current sense pin CS1, and is coupled to the second feedback pin FB2 and the second current sense pin CS2 at the same time. The switching control circuit 109 controls the first switching converter 101A to provide the first output voltage Vo1 to the bus terminal BUS1 of the first port USBC1 based on the first feedback signal VFB1 and the first current sense signal. And at the same time, the switching control circuit 109 controls the second switching converter 102A to provide the second output voltage Vo2 to the bus terminal BUS2 of the second port USBC2 based on the second feedback signal VFB2 and a second current sense signal characterizing a current flowing through the switch S2.

Although the switching converters in the embodiment of FIG. 3 are all exemplified by flyback circuits, it will be understood by those skilled in the art that this is not intended to limit the present invention. The switching converters of the present invention may also be implemented using any other suitable topology, such as FORWARD, BUCK, BOOST, and BUCK-BOOST, and switches therein may also be implemented using any suitable controllable semiconductor device.

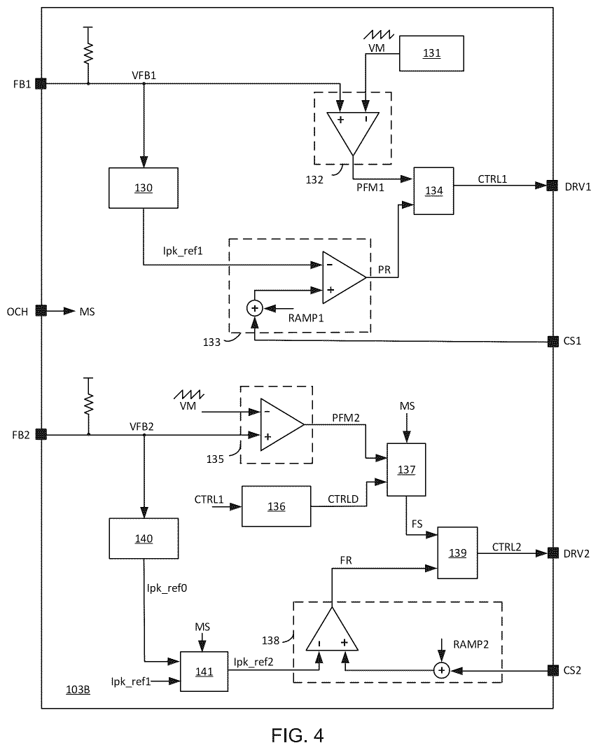

FIG. 4 schematically illustrates a circuit diagram of an integrated control circuit 103B in accordance with an embodiment of the present invention. The integrated control circuit 103B includes a modulation signal generating circuit 131, a first comparison circuit 132, a second comparison circuit 133, a first logic circuit 134, a third comparison circuit 135, a phase shift control circuit 136, a selection circuit 137, a fourth comparison circuit 138, and a second logic circuit 139.

The modulation signal generating circuit 131 is used to generate a modulation signal VM. In one embodiment, the modulation signal VM is a sawtooth wave signal. The first comparison circuit 132 has a first input terminal, a second input terminal and an output terminal. The first input terminal of the first comparison circuit 132 is coupled to the first feedback pin FB1 to receive the first feedback signal VFB1, the second input terminal of the first comparison circuit 132 is coupled to the modulation signal generating circuit 131 to receive the modulation signal VM. Based on the first feedback signal VFB1 and the modulation signal VM, the first comparison circuit 132 generates a first comparison signal PFM1 at its output terminal to control turn-on of the switch S1.

The second comparison circuit 133 has a first input terminal, a second input terminal and an output terminal. The first input terminal of the second comparison circuit 133 receives the first current sense signal representing the current flowing through the switch S1, the second input terminal of the second comparison circuit 133 receives a first threshold signal Ipk_ref1. Based on the first current sense signal and the first threshold signal Ipk_ref1, the second comparison circuit 133 generates a second comparison signal PR at its output terminal to control turn-off of the switch S1. In one embodiment, the first threshold signal Ipk_ref1 is related to the first feedback signal VFB1. The integrated control circuit 103B further comprises a current threshold generating circuit 130 coupled to the first feedback pin FB1, the current threshold generating circuit 130 generates the first threshold signal Ipk_ref1 based on the first feedback signal VFB1.

The first logic circuit 134 has a first input terminal, a second input terminal and an output terminal. The first input terminal of the first logic circuit 134 is coupled to the first comparison circuit 132 to receive the first comparison signal PFM1, the second input terminal of the first logic circuit 134 is coupled to the second comparison circuit 133 to receive the second comparison signal PR. Based on the first comparison signal PFM1 and the second comparison signal PR, the first logic circuit 134 generates the first control signal CTRL1 of the switch S1 at the output terminal and outputs the control signal CTRL1 at the first driving terminal DRV1.

Similarly, the third comparison circuit 135 has a first input terminal, a second input terminal and an output terminal. The first input terminal of the third comparison circuit 135 is coupled to the second feedback pin FB2 to receive the second feedback signal VFB2, the second input terminal of the third comparison circuit 135 is coupled to the modulation signal generating circuit 131 to receive the modulation signal VM. Based on the second feedback signal VFB2 and the modulation signal VM, the third comparison circuit 135 generates a third comparison signal PFM2 at its output terminal to control turn-on of the switch S2 in the second power supply mode.

The phase shift control circuit 136 receives the first control signal CTRL1, performs phase shifting based on the first control signal CTRL1, and generates a phase shift control signal CTRLD to control the turn-on of the switch S2 in the first power supply mode. The time period required for the switch S1 to perform a complete switching action can be defined as one period. The phase shift control circuit 136 may turn on the switch S2 a half period after the switch S1 is turned on.

The selection circuit 137 is coupled to the third feedback pin OCH to receive the mode signal MS. The selection circuit 137 selects one of the phase shift control signal CTRLD output by the phase shift control circuit 136 and the third comparison signal PFM2 output by the third comparison circuit 135 as a conduction control signal FS in response to the mode signal MS.

The fourth comparison circuit 138 has a first input terminal, a second input terminal and an output terminal. The first input terminal of the fourth comparison circuit 138 receives the second current sense signal representing the current flowing through the switch S2, the second input terminal fourth comparison circuit 138 receives a second threshold signal Ipk_ref2. The integrated control circuit 103B further comprises a current threshold generating circuit 140 coupled to the second feedback pin FB2. The current threshold generating circuit 140 generates a threshold signal Ipk_ref0 based on the second feedback signal VFB2. The selection circuit 141 is used to select the first threshold signal Ipk_ref1 or the threshold signal Ipk_ref0 as the second threshold signal Ipk_ref2 in different modes and to provide the second threshold signal Ipk_ref2 to the output terminal. Specifically, in the first power supply mode, the second threshold signal Ipk_ref2 is the same as the first threshold signal Ipk_ref1. In the second power supply mode, the second threshold signal Ipk_ref2 is the threshold signal Ipk_ref0 related to the second feedback signal VFB2. The threshold signal Ipk_ref0 is generated by the current threshold generating circuit 140 based on the second feedback signal VFB2. Based on the second current sense signal and the second threshold signal Ipk_ref2, the fourth comparison circuit 138 generates a fourth comparison signal FR at the output terminal to control turn-off of the switch S2. To maintain system stability, the second comparison circuit 133 and the fourth comparison circuit 138 often introduced with slope compensation signals, such as signals RAMP1 and RAMP2 shown in FIG. 4. The principles associated with slope compensation are well known to those skilled in the art and will not be described in detail herein.

The second logic circuit 139 has a first input terminal, a second input terminal and an output terminal. The first input terminal of the second logic circuit 139 is coupled to the selection circuit 137 to receive the selected conduction control signal FS, the second input terminal of the second logic circuit 139 is coupled to the fourth comparison circuit 138 to receive the fourth comparison signal FR. Based on the conduction control signal FS and the fourth comparison signal FR, the second logic circuit 139 generates the second control signal CTRL2 at the output terminal to control the switch S2.

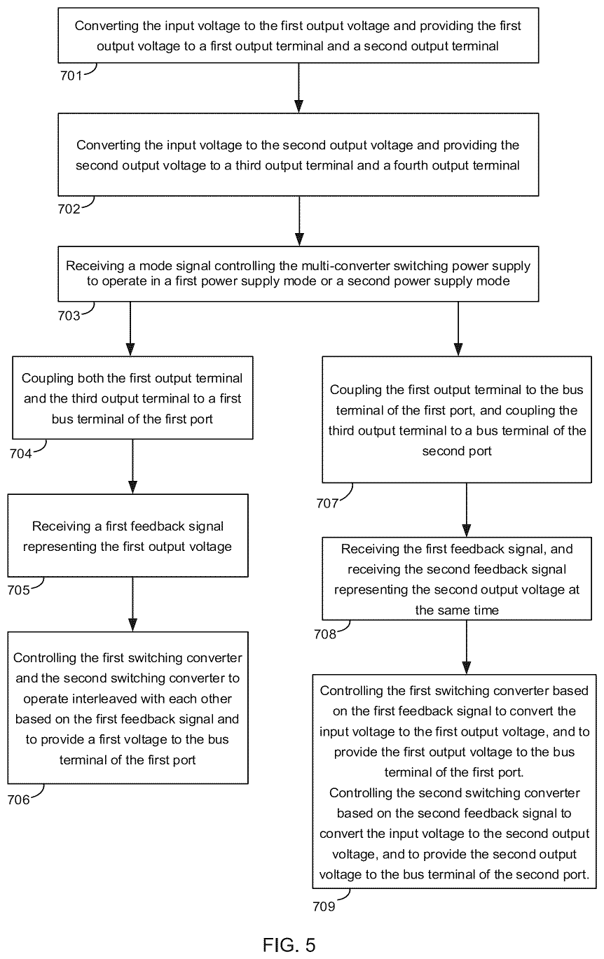

FIG. 5 schematically illustrates a flowchart of a control method for a multi-converter switching power supply in accordance with an embodiment of the present invention. The multi-converter switching power supply comprises a first switching converter having a first output capacitor, and a second switching converter having a second output capacitor. The first switching converter converts an input voltage to a first output voltage, and the second switching converter converts the input voltage to a second output voltage. The control method comprises steps 701 to 709.

At the step 701, converting the input voltage to the first output voltage and providing the first output voltage to a first output terminal and a second output terminal. The first output capacitor is coupled between the first output terminal and the second output terminal.

At the step 702, converting the input voltage to the second output voltage and providing the second output voltage to a third output terminal and a fourth output terminal. The second output terminal is coupled to the fourth output terminal, and the second output capacitor is coupled between the third output terminal and the fourth output terminal.

At the step 703, receiving a mode signal controlling the multi-converter switching power supply to operate in a first power supply mode or a second power supply mode in response to the multi-converter switching power supply operates in the first power supply mode, entering steps 704 to 706. In response to the multi-converter switching power supply operates in the second power supply mode, entering steps 707 to 709.

In one embodiment, when the multi-converter switching power supply operates in the first power supply mode, only a first port is coupled to a first electronic device, and when the multi-converter switching power supply operates in a second power supply mode, the first port is coupled to the first electronic device while the second port is coupled to a second electronic device.

At the step 704, coupling both the first output terminal and the third output terminal to a bus terminal of the first port.

At the step 705, receiving a first feedback signal representing the first output voltage.

At the step 706, controlling the first switching converter and the second switching converter to operate interleaved with each other based on the first feedback signal and to provide a first voltage to the bus terminal of the first port.

At the step 707, in response to the multi-converter switching power supply is operating in the second power supply mode, coupling the first output terminal to the bus terminal of the first port, and coupling the third output terminal to a bus terminal of the second port.

At the step 708, receiving the first feedback signal, and receiving the second feedback signal representing the second output voltage at the same time.

At the step 709, controlling the first switching converter based on the first feedback signal to convert the input voltage to the first output voltage, and to provide the first output voltage to the bus terminal of the first port. Controlling the second switching converter based on the second feedback signal to convert the input voltage to the second output voltage, and to provide the second output voltage to the bus terminal of the second port.

In an embodiment of the present invention, when only the first port is coupled to the first electronic device, the first switching converter and the second switching converter are automatically configured to operate interleaved with each other, providing double load capacity to the first electronic device, so that the power supply requirements of the high power load can be satisfied. When the second port is further coupled to the second electronic device, the first switching converter and the second switching converter are reconfigured to have their inputs connected in parallel and their outputs independent from each other to provide corresponding output voltages for the first electronic device and the second electronic device respectively, in order to meet the power supply requirements of multiple loads.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A multi-converter switching power supply, comprising:
a first switching converter configured to receive an input voltage, to convert the input voltage to a first output voltage, and to provide the first output voltage to a first output terminal and a second output terminal;
a second switching converter configured to receive the input voltage, to convert the input voltage to a second output voltage, and to provide the second output voltage to a third output terminal and a fourth output terminal, wherein the second output terminal is coupled to the fourth output terminal;
a first port having a first bus terminal for receiving a first voltage and a first ground terminal coupled to the second output terminal;
a second port having a second bus terminal for receiving a second voltage and a second ground terminal coupled to the fourth output terminal; and
an integrated control circuit comprising:
a first pin configured to receive a first feedback signal representing the first output voltage;
a second pin configured to receive a second feedback signal representing the second output voltage;
a third pin configured to receive a mode signal, wherein the mode signal is configured to control the multi-converter switching power supply to operate in a first power supply mode or a second power supply mode; and
a switching control circuit configured to control the first switching converter and the second switching converter, wherein
when the multi-converter switching power supply operates in the first power supply mode, the first output terminal and the third output terminal are both coupled to the first bus terminal, the switching control circuit is configured to control the first switching converter and the second switching converter to operate interleaved with each other based on the first feedback signal;
when the multi-converter switching power supply operates in the second power supply mode, the first output terminal is coupled to the first bus terminal, the third output terminal is coupled to the second bus terminal, the switching control circuit is configured to control the first switching converter to provide the first voltage based on the first feedback signal, and the switching control circuit is further configured to control the second switching converter to provide the second voltage based on the second feedback signal.

2. The multi-converter switching power supply of claim 1, wherein:
when the first port is coupled to a first electronic device, while the second port is floating, the multi-converter switching power supply is controlled to operate in the first power supply mode; and wherein
when the first port is coupled to the first electronic device and the second port is coupled to a second electronic device, the multi-converter switching power supply is controlled to operate in the second power supply mode.

3. The multi-converter switching power supply of claim 2, wherein when the multi-converter switching power supply operates in the first power supply mode, the first pin of the integrated control circuit receives the first feedback signal via a first isolated delivery path, wherein the first feedback signal is an error amplifying signal of the first output voltage.

4. The multi-converter switching power supply of claim 3, wherein when the multi-converter switching power supply operates in the first power supply mode, the second pin of the integrated control circuit receives the second feedback signal via a second isolated delivery path, wherein the second feedback signal is an error amplifying signal of the second output voltage.

5. The multi-converter switching power supply of claim 2, further comprising:
a power delivery controller having a first terminal and a second terminal, wherein the first terminal of the power delivery controller is coupled to the first port and the second terminal of the power delivery controller is coupled to the second port, and wherein the power delivery controller is configured to detect whether the multi-converter switching power supply should operate in the first power supply mode or the second power supply mode.

6. The multi-converter switching power supply of claim 5, further comprising:
a load switch having a first terminal, a second terminal, and a control terminal, wherein the first terminal of the load switch is coupled to the first output terminal, the second terminal of the load switch is coupled to the third output terminal, and the control terminal of the load switch is coupled to a third terminal of the power delivery controller, wherein the load switch is turned on when the multi-converter switching power supply operates in the first power supply mode, and the load switch is turned off when the multi-converter switching power supply operates in the second power supply mode.

7. The multi-converter switching power supply of claim 5, further comprising a third isolated delivery path, wherein the third isolated delivery path comprises:
a photosensitive diode having an anode and a cathode, wherein the anode is coupled to the third output terminal via a feedback resistor, the cathode is coupled to a fourth terminal of the power delivery controller, and the photosensitive diode is configured to convert a signal related to the second output voltage to a current flowing through the photosensitive diode; and
a photosensitive transistor coupled to the third pin of the integrated control circuit, wherein the photosensitive transistor is configured to provide the mode signal in response to the current flowing through the photosensitive diode.

8. The multi-converter switching power supply of claim 1, wherein the switching control circuit comprises:
a modulation signal generating circuit configured to generate a modulation signal;
a first comparison circuit coupled to the modulation signal generating circuit, wherein the first comparison circuit is configured to generate a first comparison signal based on the modulation signal and the first feedback signal;
a second comparison circuit configured to generate a second comparison signal based on a first current sense signal representing a current flowing through a first switch in the first switching converter and a first threshold signal;
a first logic circuit coupled to the first comparison circuit and the second comparison circuit, wherein the first logic circuit is configured to generate a first control signal based on the first comparison signal and the second comparison signal to control the first switch;
a phase shift control circuit coupled to the first logic circuit to receive the first control signal, wherein the phase shift control circuit is configured to phase shift the first control signal to generate a phase shift control signal;
a third comparison circuit coupled to the modulation signal generating circuit, wherein the third comparison circuit is configured to generate a third comparison signal based on the modulation signal and the second feedback signal;
a selection circuit configured to select one of the phase shift control signal and the third comparison signal as a conduction control signal based on the mode signal;
a fourth comparison circuit configured to generate a fourth comparison signal based on a second current sense signal representing a current flowing through a second switch in the second switching converter and a second threshold signal; and
a second logic circuit coupled to the selection circuit and the fourth comparison circuit, wherein the second logic circuit is configured to generate a second control signal based on the conduction control signal and the fourth comparison signal to control the second switch.

9. The multi-converter switching power supply of claim 8, wherein:
when the multi-converter switching power supply operates in the first power supply mode, the first threshold signal is related to the first feedback signal, and the second threshold signal is the same as the first threshold signal; and wherein
when the multi-converter switching power supply operates in the second power supply mode, the first threshold signal is related to the first feedback signal, and the second threshold signal is related to the second feedback signal.

10. The multi-converter switching power supply of claim 8, further comprising:
a first current threshold generating circuit coupled to the first pin, wherein the first current threshold generating circuit is configured to generate the first threshold signal based on the first feedback signal; and
a second current threshold generating circuit coupled to the second pin, wherein the second current threshold generating circuit is configured to generate the second threshold signal based on the second feedback signal.

11. An integrated control circuit for a multi-converter switching power supply, comprising:
a first pin configured to receive a first feedback signal representing a first output voltage of the multi-converter switching power supply;
a second pin configured to receive a second feedback signal representing a second output voltage of the multi-converter switching power supply;
a third pin configured to receive a mode signal controlling the multi-converter switching power supply to operate in a first power supply mode or a second power supply mode; and
a switching control circuit configured to control a first switching converter and a second switching converter of the multi-converter switching power supply, wherein
when the multi-converter switching power supply operates in the first power supply mode, inputs of a first switching converter of the multi-converter switching power supply and inputs of a second switching converter of the multi-converter switching power supply are connected in parallel, and outputs of the first switching converter and outputs of the second switching converter are connected in parallel, the switching control circuit is configured to control the first switching converter and the second switching converter to operate interleaved with each other based on the first feedback signal to provide a first voltage to a first bus terminal of a first port;
when the multi-converter switching power supply operates in a second power supply mode, the inputs of the first switching converter and the inputs of the second switching converter are connected in parallel, the switching control circuit is configured to control the first switching converter to provide the first output voltage to the first bus terminal of the first port based on the first feedback signal, the switching control circuit is further configured to control the second switching converter to provide the second output voltage to a second bus terminal of a second port based on the second feedback signal.

12. The integrated control circuit of claim 11, wherein:
when the multi-converter switching power supply operates in the first power supply mode, the first port is coupled to a first electronic device, and the second port is floating; and wherein when the multi-converter switching power supply operates in the second power supply mode, the first port is coupled to the first electronic device, and the second port is coupled to a second electronic device.

13. The integrated control circuit of claim 12, wherein the switching control circuit comprises:
a modulation signal generating circuit configured to generate a modulation signal;
a first comparison circuit coupled to the modulation signal generating circuit, wherein the first comparison circuit is configured to generate a first comparison signal based on the modulation signal and the first feedback signal;
a second comparison circuit configured to generate a second comparison signal based on a first current sense signal representing a current flowing through a first switch in the first switching converter and a first threshold signal;
a first logic circuit coupled to the first comparison circuit and the second comparison circuit, wherein the first logic circuit is configured to generate a first control signal based on the first comparison signal and the second comparison signal to control the first switch;
a phase shift control circuit coupled to the first logic circuit to receive the first control signal, wherein the phase shift control circuit is configured to phase shift the first control signal to generate a phase shift control signal;
a third comparison circuit coupled to the modulation signal generating circuit, wherein the third comparison circuit is configured to generate a third comparison signal based on the modulation signal and the second feedback signal;
a selection circuit configured to select the phase shift control signal or the third comparison signal as a conduction control signal based on the mode signal;
a fourth comparison circuit configured to generate a fourth comparison signal based on a second current sense signal representing a current flowing through a second switch in the second switching converter and a second threshold signal; and
a second logic circuit coupled to the selection circuit and the fourth comparison circuit, wherein the second logic circuit is configured to generate a second control signal based on the conduction control signal and the fourth comparison signal to control the second switch.

14. The integrated control circuit of claim 13, wherein:
when the multi-converter switching power supply operates in the first power supply mode, the first threshold signal is related to the first feedback signal, and the second threshold signal is the same as the first threshold signal; and wherein
when the multi-converter switching power supply operates in the second power supply mode, the first threshold signal is related to the first feedback signal, and the second threshold signal is related to the second feedback signal.

15. The integrated control circuit of claim 13, further comprising:
a first current threshold generating circuit coupled to the first pin, wherein the first current threshold generating circuit is configured to generate the first threshold signal based on the first feedback signal.

16. The integrated control circuit of claim 13, further comprising:
a second current threshold generating circuit coupled to the second pin, wherein the second current threshold generating circuit is configured to generate the second threshold signal based on the second feedback signal.

17. The integrated control circuit of claim 11, wherein in the first power supply mode, the first pin of the integrated control circuit receives the first feedback signal via a first isolated delivery path, wherein the first feedback signal is an error amplifying signal of the first output voltage.

18. The integrated control circuit of claim 11, wherein when the multi-converter switching power supply operates, the second pin of the integrated control circuit receives the second feedback signal via a second isolated delivery path, wherein the second feedback signal is an error amplifying signal of the second output voltage.

19. A control method for a multi-converter switching power supply, comprising:
converting an input voltage to a first output voltage and providing the first output voltage to a first output terminal and a second output terminal;
converting the input voltage to a second output voltage and providing the second output voltage to a third output terminal and a fourth output terminal, wherein the second output terminal is coupled to the fourth output terminal; and
receiving a mode signal controlling the multi-converter switching power supply to operate in a first power supply mode or a second power supply mode; wherein
in response to the multi-converter switching power supply operating in the first power supply mode, coupling both the first output terminal and the third output terminal to a first bus terminal of a first port, receiving a first feedback signal representing the first output voltage, and controlling a first switching converter of the multi-converter switching power supply and a second switching converter of the multi-converter switching power supply to operate interleaved with each other based on the first feedback signal to provide a first voltage for the first bus terminal; and wherein
in response to the multi-converter switching power supply operating in the second power supply mode, coupling the first output terminal to the first bus terminal, coupling the third output terminal to a second bus terminal of a second port, receiving the first feedback signal, and receiving a second feedback signal representing the second output voltage at the same time, controlling the first switching converter to convert the input voltage to the first output voltage based on the first feedback signal, and to provide the first output voltage to the first bus terminal, and controlling the second switching converter to convert the input voltage to the second output voltage based on the second feedback signal, and to provide the second output voltage to the second bus terminal.

20. The control method of claim 19, wherein in the first power supply mode, the first port is coupled to the first electronic device and the second port is floating, and in the second power supply mode, the first port is coupled to the first electronic device and the second port is coupled to the second electronic device.
